(19) United States
(12) Patent Application Publication
(10) Pub. No.: US 2018/0331846 A1
(43) Pub. Date: Nov. 15, 2018

(54) ACTIVITY BASED AUTOMATION

(71) Applicant: Vivint, Inc., Provo, UT (US)

(72) Inventor: Benjamin Meakin, Sandy, UT (US)

(21) Appl. No.: 15/590,698

(22) Filed: May 9, 2017

(51) Int. Cl. H04L 12/28; G08B 25/08; H04M 1/725

(52) U.S. Cl. CPC H04L 12/2825; H04L 12/2827; H04L 12/282; G05B 2219/2642; H04L 12/2836; H04M 1/72533; H04L 12/2803; G08B 25/08

(57) ABSTRACT

A method for security and/or automation systems is described. In one embodiment, the method includes identifying, via a processor of an automation system, a status of an occupant of a premises, determining, via the processor, a setting of an automated device associated with the status of the occupant, and implementing, via the processor, the setting of the automated device upon identifying the status of the occupant. In some cases, the status of the occupant includes at least one of an action of the occupant and a location of the action.

### BACKGROUND

The present disclosure, for example, relates to security and/or automation systems, and more particularly to improving automation systems.

Security and automation systems are widely deployed to provide various types of communication and functional features such as monitoring, communication, notification, and/or others. These systems may be capable of supporting communication with a user through a communication connection or a system management action.

Conventional automation systems require a user to set up complex instructions and conditions to implement automated tasks. In some cases, a user may need an expert to set up an automation system due to the complexity of the configuration process.

### SUMMARY

The disclosure herein includes methods and systems for improving automation systems. In some embodiments, the present systems and methods may include improving automation system configurations.

A method for security and/or automation systems is described. In one embodiment, the method may include identifying, via a processor of an automation system, a status of an occupant of a premises, determining, via the processor, a setting of an automated device associated with the status of the occupant, and implementing, via the processor, the setting of the automated device upon identifying the status of the occupant. In some cases, the status of the occupant may include at least one of an action of the occupant and a location of the action.

In some embodiments, the method may include receiving from the occupant the action of the occupant and the location of the action. In some embodiments, the method may include searching a database associated with the automation system for an entry in the database that matches from the identified status of the occupant at least one of the action of the occupant and the location of the action.

In some embodiments, the method may include identifying a matching entry of the database based at least in part on the search identifying the setting of the automated device in the matching entry. In some embodiments, the method may include receiving from the occupant the action of the occupant without the location of the action. In some embodiments, the method may include implementing the setting of the automated device upon determining the received action is associated with a preconfigured location.

In some embodiments, the method may include implementing the setting of the automated device upon determining the received action is location independent. Upon determining the received action is location dependent and not associated with a preconfigured location, the method may include performing a query of the occupant for information regarding the location that may include at least one of sending a text message to the occupant, sending an email message to the occupant, playing a prerecorded message over a speaker at the premises, playing a text to speech message over the speaker, or any combination thereof.

In some cases, a location independent action may include at least one of reading, operating a mobile computing device or laptop computing device, cleaning the premises, exercising in the premises, exercising outside the premises, gardening outside the premises, or any combination thereof. In some examples, a location dependent action may include at least one of food preparation, washing dishes, doing laundry, operating a television, operating a desktop computer, or any combination thereof. In some cases, the occupant may provide the occupant status to the automation system via a voice command, via a menu selection on a computing device, via a menu selection on a control panel, or a combination thereof.

An apparatus for security and/or automation systems is also described. In one embodiment, the apparatus may include a processor, memory in electronic communication with the processor, and instructions stored in the memory, the instructions being executable by the processor to perform the steps of identifying a status of an occupant of a premises, determining a setting of an automated device associated with the status of the occupant, and implementing the setting of the automated device upon identifying the status of the occupant. In some cases, the status of the occupant may include at least one of an action of the occupant and a location of the action.

A non-transitory computer-readable medium is also described. The non-transitory computer readable medium may store computer-executable code, the code being executable by a processor to perform the steps of identifying a status of an occupant of a premises, determining a setting of an automated device associated with the status of the occupant, and implementing the setting of the automated device upon identifying the status of the occupant. In some cases, the status of the occupant may include at least one of an action of the occupant and a location of the action.

The foregoing has outlined rather broadly the features and technical advantages of examples according to this disclosure so that the following detailed description may be better understood. Additional features and advantages will be described below. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein—including their organization and method of operation—together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following a first reference label with a dash and a second label that may distinguish among the similar components. However, features discussed for various components—including those having a dash and a second reference label—apply to other similar components. If only the first reference label is used in the specification, the description is applicable to any one of the similar components having the same first reference label irrespective of the second reference label.

FIG. 1 is a block diagram of an example of a security and/or automation system in accordance with various embodiments;

FIG. 2 shows a block diagram of a data flow relating to a security and/or an automation system, in accordance with various aspects of this disclosure;

FIG. 3 shows a block diagram of a device relating to a security and/or an automation system, in accordance with various aspects of this disclosure;

FIG. 4 shows a block diagram of a device relating to a security and/or an automation system, in accordance with various aspects of this disclosure;

FIG. 5 shows a block diagram relating to a security and/or an automation system, in accordance with various aspects of this disclosure;

FIG. 6 is a flow chart illustrating an example of a method relating to a security and/or an automation system, in accordance with various aspects of this disclosure;

FIG. 7 is a flow chart illustrating an example of a method relating to a security and/or an automation system, in accordance with various aspects of this disclosure; and

FIG. 8 is a flow chart illustrating an example of a method relating to a security and/or an automation system, in accordance with various aspects of this disclosure.

### DETAILED DESCRIPTION

The following relates generally to automation and/or security systems. Automation systems may include one or more sensors and/or automated devices located in various locations of a premises. For example, sensors may include at least one of a camera sensor, a motion sensor, a proximity sensor, and/or an audio sensor, or any combination thereof. In some cases, automated devices may include automated light switches, automated thermostats, automated door locks, automated appliances, automated heating ventilation and air conditioning (HVAC) systems, or any combination thereof.

A conventional automation system may be programmed to perform one or more automated actions based on a complex setup procedure. As one example, an occupant may have study how to configure a first rule, and then after learning how to configure the first rule, program the automation system to implement the first rule. The occupant may then have to study how to configure a second rule different from the first rule, and then again after learning how to configure the second rule, program the automation system to implement the second rule. In some cases, a conventional automation system may have the user pre-determine a set of devices and settings to recall at a time that is also specified by the user. In some cases, the conventional home automation system may limit customization to tech savvy customers or customers with the means to pay a dealership to manage and configure their automations for them. Thus, a conventional automation system may be complex and time consuming from an occupant's point of view. Accordingly, in some cases, an occupant may forego programming an automation system due to the requisite time and/or complexity involved with programming the automation system.

The present systems and methods may relate to improving automation systems in relation to a current activity of an occupant of a premises. In one embodiment, the present systems and methods may improve upon the complexity and time constraints of a conventional automation system. In some cases, the present systems and methods may enable a user to implement automation configuration settings based on the automation system identifying an action and/or a location of an occupant. In some embodiments, the present systems and methods may detect at least one of an activity and a location as inputs. In some embodiments, receiving an input may include the present systems and methods detecting an activity and/or a location by receiving and/or interpreting spoken or written language from a user, detecting a learned pattern of activity, analysis of a camera that is monitoring activity in a location, or any combination thereof. Given at least one of these inputs, the present systems and methods may dynamically identify automated devices associated with an indicated location and adjust settings on those devices according to the given activity.

In one embodiment, an occupant may state, “I'm doing taxes in the office.” In some cases, the automation system may perform a query of a database for an entry that matches “doing taxes” and/or “in the office.” In one example, a database associated with the automation system may be preconfigured to recognize one or more circumstances of an occupant of a premises. The database may be located at the premises and/or at a remote location such as in a cloud storage system associated with the automation system. Upon finding a match, the automation system may identify one or more automation configuration settings associated with the action “doing taxes” and/or the location “office.” In some cases, the one or more automation configuration settings may be settings of one or more automated devices associated with the automation system. Upon detecting the match, the automation system may implement at least one of the one or more associated automation configuration settings. As one example, adjusting the automation configuration settings of an automated device at a premises may include adjusting an automated light switch, adjusting an automated thermostat, adjusting an automated audio signal on a speaker of the premises, adjusting an automated camera, adjusting an automated door lock, adjusting an automated sensor, adjusting an automated computing device, adjusting an automated utility device such as an HVAC device or an indoor plumbing device, adjusting an automated appliance, or any combination thereof.

In some cases, the automation system may not recognize the action and/or location provided by the occupant. When the automation system does not recognize either the action or the location, or both the action and the location, in some cases the automation system may query the occupant for information regarding the action, the location, one or more automation configuration settings to associate with the action and/or location, or any combination thereof. In some cases, the automation system may ask an occupant whether to update the database based on information the occupant provides in response to the query made by the automation system.

As one example, the automation system may not recognize “doing taxes,” but may identify in a database one or more automation configuration settings associated with the location “office” in the premises. Accordingly, automation system may ask the occupant whether to apply at least one of the one or more automation configuration settings associated with the location “office.” In an example implementation, the automation system may state, “I do not recognize the action ‘doing taxes,’ but I have a lighting setting for ‘office.’ Would you like me to implement this lighting setting?” Additionally, or alternatively, the automation system may state, “I do not recognize the action ‘doing taxes.’ Would you like me to associate an automation configuration setting with the action ‘doing taxes’?” and based on the response from the occupant the automation system may generate a new association between the action “doing taxes” and one or more automation configuration settings. In one example, the automation system may modify a setting of an existing database entry for the action “doing taxes” and/or the location “the office” based on the response from the occupant.

In some cases, the occupant may provide one or more automation configuration settings for the action “doing taxes” and/or the location “the office.” As one example, the occupant may tell the automation system to associate “doing taxes” and/or the location “the office” with at least one of adjusting a light in the office such as turning on or off a light, adjusting a light in the office to a certain dimming level, setting the temperature setting for the office to a certain temperature value, playing certain music over a speaker in the office, adjusting a setting of a security camera in the office, adjusting a setting of a sensor in the office, making a permanent association between the action “doing taxes” and the location “office,” or any combination thereof.

As one example, the occupant may do taxes at least once in the kitchen of the premises. Accordingly, the occupant may notify the automation system that the occupant is doing taxes in the kitchen. Upon receiving this notification, the automation system may implement one or more automation configuration settings of automated devices in the kitchen based on the stored automation configuration settings associated with the action “doing taxes.” Even in the situation where “doing taxes” is preconfigured to be associated with “office,” the automation system may adjust the system based on the provided location “kitchen.” In one embodiment, the occupant may provide a new automation configuration setting based on the new location. In some cases, the automation system may generate a new entry in the database that includes an association between “doing taxes” and the location “kitchen” based on the received notification and/or new information provided by the occupant. For example, the occupant may instruct the automation system to brew coffee in relation to doing taxes in the kitchen. Accordingly, the automation system may add an automation configuration setting of instructing an automated coffee brewer to brew coffee upon receiving notification from the occupant that he/she is doing taxes in the kitchen.

In one embodiment, when an occupant provides an action to the automation system that is preconfigured to a certain location, the automation system may implement automation configuration settings of automated devices in the predetermined location based on the stored permanent association between the action and the preconfigured location. For example, when the occupant states “I'm doing taxes” without providing a location and “doing taxes” is preconfigured to be associated with “office,” the automation system may implement one or more automation configuration settings of automated devices in the office based on the stored permanent association between “doing taxes” and the preconfigured location “office” and the automation configuration settings associated with the action “doing taxes” and the preconfigured location “office.”

In one embodiment, an action of an occupant may be saved in a database without an associated location. For example, actions such as reading, cleaning, exercising, and the like may be associated with one or more automation configuration settings, but not associated with a particular location. Accordingly, whether an occupant states, “I'm reading in my bedroom” or “I'm reading in the living room,” the automated system may implement the one or more automation configuration settings for the location provided with the action.

In some embodiments, the automation system may learn preferences of a particular occupant. The preferences of the occupant may include a temperature preference, a lighting preference, a music preference, a security camera preference, a motion sensor preference, or any combination thereof. For example, the occupant may state “I'm exercising in the basement.” In response, the automation system may determine what music the occupant likes to listen to while exercising, a light setting preferred by the occupant while exercising, a temperature setting preferred by the occupant while exercising, or any combination thereof, and implement the preferences of the occupant upon identifying a notification from the occupant that he/she is exercising.

In some embodiments, the automation system may be configured to recognize the identity of one or more occupants of a premises. As one example, the automation system may determine the identity of the occupant based at least in part on detection of a signal associated with an occupant such as a signal from a mobile computing device of an occupant, facial recognition of an occupant, analysis of an occupant's voice upon receiving a status notification from the occupant, or any combination thereof. In some cases, an automation configuration setting may be implemented conditionally based at least in part on an identity of an occupant providing a notification, a time of day, a current outdoor temperature, a current temperature in the premises, a current temperature in a certain room of the premises, music currently playing in a room of the premises, or any combination thereof. As one example, a light setting may be implemented when the time of day is within a first time range such as between 5:00 PM and 7:00 AM, but not implemented when the time of day is within a second time range such as from 7:00 AM to 5:00 PM.

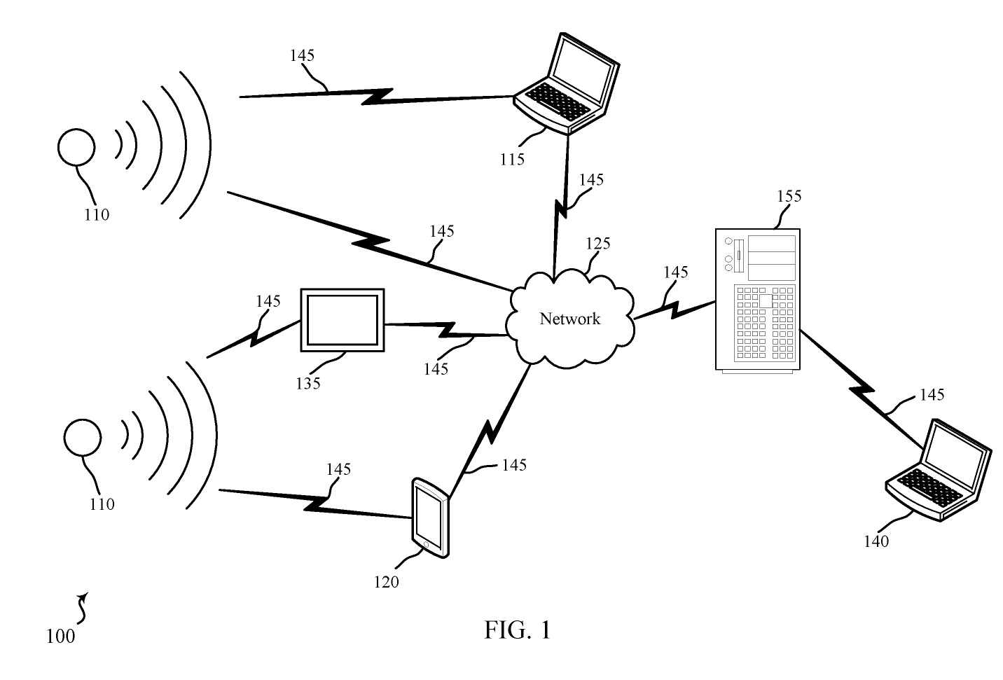

FIG. 1 is an example of a communications system 100 in accordance with various aspects of the disclosure. In some embodiments, the communications system 100 may include one or more sensor units 110, local computing device 115, 120, network 125, server 155, control panel 135, and remote computing device 140. One or more sensor units 110 may communicate via wired or wireless communication links 145 with one or more of the local computing device 115, 120 or network 125. The network 125 may communicate via wired or wireless communication links 145 with the control panel 135 and the remote computing device 140 via server 155. In alternate embodiments, the network 125 may be integrated with any one of the local computing device 115, 120, server 155, and/or remote computing device 140, such that separate components are not required.

Local computing device 115, 120 and remote computing device 140 may be custom computing entities configured to interact with sensor units 110 via network 125, and in some embodiments, via server 155. In other embodiments, local computing device 115, 120 and remote computing device 140 may be general purpose computing entities such as a personal computing device, for example, a desktop computer, a laptop computer, a netbook, a tablet personal computer (PC), a control panel, an indicator panel, a multi-site dashboard, an IPOD®, an IPAD®, a smart phone, a mobile phone, a personal digital assistant (PDA), and/or any other suitable device operable to send and receive signals, store and retrieve data, and/or execute modules.

Control panel 135 may be a smart home system panel, for example, an interactive panel mounted on a wall in a user's home. Control panel 135 may be in direct communication via wired or wireless communication links 145 with the one or more sensor units 110, or may receive sensor data from the one or more sensor units 110 via local computing devices 115, 120 and network 125, or may receive data via remote computing device 140, server 155, and network 125.

The local computing devices 115, 120 may include memory, at least one processor, an output, a data input and a communication module. The processor may be a general purpose processor, a Field Programmable Gate Array (FPGA), an Application Specific Integrated Circuit (ASIC), a Digital Signal Processor (DSP), and/or the like. The processor may be configured to retrieve data from and/or write data to the memory. The memory may be, for example, a random access memory (RAM), a memory buffer, a hard drive, a database, an erasable programmable read only memory (EPROM), an electrically erasable programmable read only memory (EEPROM), a read only memory (ROM), a flash memory, a hard disk, a floppy disk, cloud storage, and/or so forth. In some embodiments, the local computing devices 115, 120 may include one or more hardware-based modules (e.g., DSP, FPGA, ASIC) and/or software-based modules (e.g., a module of computer code stored at the memory and executed at the processor, a set of processor-readable instructions that may be stored at the memory and executed at the processor) associated with executing an application, such as, for example, receiving and displaying data from sensor units 110.

The processor of the local computing devices 115, 120 may be operable to control operation of the output of the local computing devices 115, 120. The output may be a television, a liquid crystal display (LCD) monitor, a cathode ray tube (CRT) monitor, speaker, tactile output device, and/or the like. In some embodiments, the output may be an integral component of the local computing devices 115, 120. Similarly stated, the output may be directly coupled to the processor. For example, the output may be the integral display of a tablet and/or smart phone. In some embodiments, an output module may include, for example, a High Definition Multimedia Interface™ (HDMI) connector, a Video Graphics Array (VGA) connector, a Universal Serial Bus™ (USB) connector, a tip, ring, sleeve (TRS) connector, and/or any other suitable connector operable to couple the local computing devices 115, 120 to the output.

The remote computing device 140 may be a computing entity operable to enable a remote user to monitor the output of the sensor units 110. The remote computing device 140 may be functionally and/or structurally similar to the local computing devices 115, 120 and may be operable to receive data streams from and/or send signals to at least one of the sensor units 110 via the network 125. The network 125 may be the Internet, an intranet, a personal area network, a local area network (LAN), a wide area network (WAN), a virtual network, a telecommunications network implemented as a wired network and/or wireless network, etc. The remote computing device 140 may receive and/or send signals over the network 125 via wireless communication links 145 and server 155.

In some embodiments, the one or more sensor units 110 may be sensors configured to conduct periodic or ongoing automatic measurements related to audio and/or image data signals. Each sensor unit 110 may be capable of sensing multiple audio and/or image parameters, or alternatively, separate sensor units 110 may monitor separate audio and image parameters. For example, one sensor unit 110 may monitor audio (e.g., spoken occupant status, voice commands, etc.), while another sensor unit 110 (or, in some embodiments, the same sensor unit 110) may detect images (e.g., photo and/or video of an occupant, motion detection, infrared, etc.). In some embodiments, one or more sensor units 110 may additionally monitor alternate audio and/or image parameters, such as gestures or patterns of gestures of an occupant, etc.

Data gathered by the one or more sensor units 110 may be communicated to local computing device 115, 120, which may be, in some embodiments, a thermostat or other wall-mounted input/output smart home display. In other embodiments, local computing device 115, 120 may be a personal computer and/or smart phone. Where local computing device 115, 120 is a smart phone, the smart phone may have a dedicated application directed to collecting audio and/or video data and calculating object detection therefrom. The local computing device 115, 120 may process the data received from the one or more sensor units 110 to obtain a probability of an object within an area of a premises such as an object within a predetermined distance of an entrance to the premises as one example. In alternate embodiments, remote computing device 140 may process the data received from the one or more sensor units 110, via network 125 and server 155, to obtain a probability of detecting an object within the vicinity of an area of a premises, such as detecting a person at an entrance to the premises for example. Data transmission may occur via, for example, frequencies appropriate for a personal area network (such as BLUETOOTH® or IR communications) or local or wide area network frequencies such as radio frequencies specified by the IEEE 802.15.4 standard, among others.

In some embodiments, local computing device 115, 120 may communicate with remote computing device 140 or control panel 135 via network 125 and server 155. Examples of networks 125 include cloud networks, local area networks (LAN), wide area networks (WAN), virtual private networks (VPN), wireless networks (using 802.11, for example), and/or cellular networks (using 3G and/or LTE, for example), etc. In some configurations, the network 125 may include the Internet. In some embodiments, a user may access the functions of local computing device 115, 120 from remote computing device 140. For example, in some embodiments, remote computing device 140 may include a mobile application that interfaces with one or more functions of local computing device 115, 120.

The server 155 may be configured to communicate with the sensor units 110, the local computing devices 115, 120, the remote computing device 140 and control panel 135. The server 155 may perform additional processing on signals received from the sensor units 110 or local computing devices 115, 120, or may simply forward the received information to the remote computing device 140 and control panel 135.

Server 155 may be a computing device operable to receive data streams (e.g., from sensor units 110 and/or local computing device 115, 120 or remote computing device 140), store and/or process data, and/or transmit data and/or data summaries (e.g., to remote computing device 140). For example, server 155 may receive a stream of passive audio data from a sensor unit 110, a stream of active audio data from the same or a different sensor unit 110, a stream of image (e.g., photo and/or video) data from either the same or yet another sensor unit 110, and a stream of motion data from either the same or yet another sensor unit 110.

In some embodiments, server 155 may “pull” the data streams, e.g., by querying the sensor units 110, the local computing devices 115, 120, and/or the control panel 135. In some embodiments, the data streams may be “pushed” from the sensor units 110 and/or the local computing devices 115, 120 to the server 155. For example, the sensor units 110 and/or the local computing device 115, 120 may be configured to transmit data as it is generated by or entered into that device. In some instances, the sensor units 110 and/or the local computing devices 115, 120 may periodically transmit data (e.g., as a block of data or as one or more data points).

The server 155 may include a database (e.g., in memory and/or through a wired and/or a wireless connection) containing audio and/or video data received from the sensor units 110 and/or the local computing devices 115, 120. Additionally, as described in further detail herein, software (e.g., stored in memory) may be executed on a processor of the server 155. Such software (executed on the processor) may be operable to cause the server 155 to monitor, process, summarize, present, and/or send a signal associated with resource usage data.

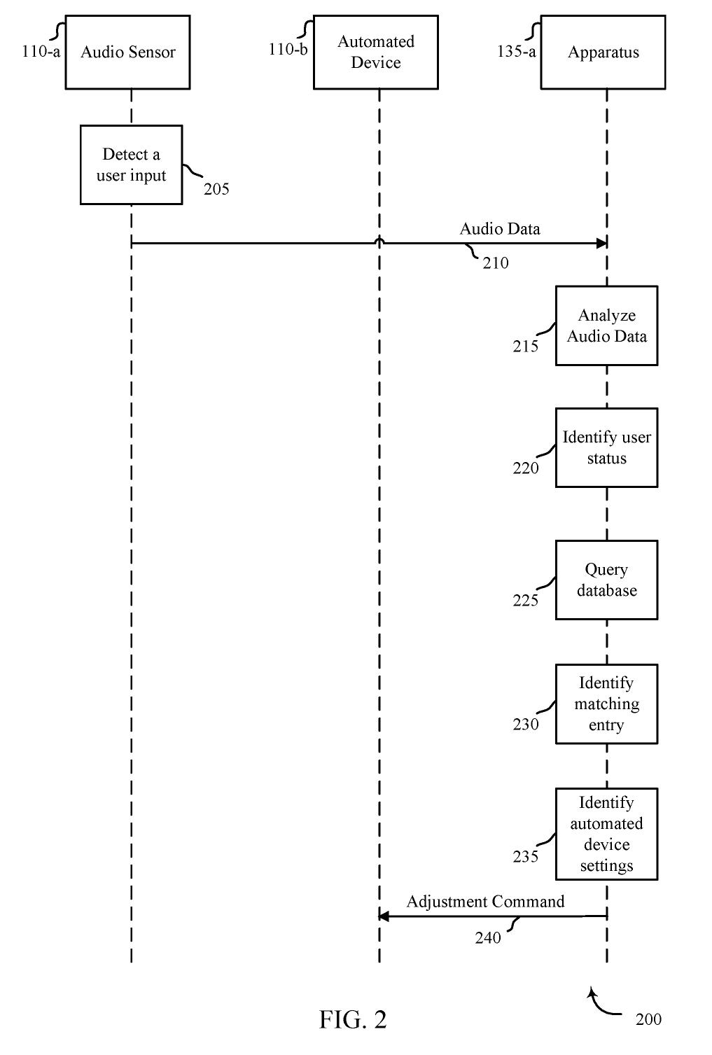

FIG. 2 shows a block diagram of a data flow 200 relating to a security and/or an automation system, in accordance with various aspects of this disclosure. The data flow 200 illustrates the flow of data between an audio sensor 110-a, an automated device 110-b, and an apparatus 135-a. The audio sensor and/or automated device 110 may be examples of one or more aspects of sensor 110 from FIG. 1. Apparatus 135-a may be an example of one or more aspects of control panel 135 of FIG. 1. In some cases, apparatus 135-a may include a computing device such as a smart phone, desktop, laptop, remote server (e.g., server 155 of FIG. 1). In some cases, apparatus 135-a may include a storage device and/or database.

At block 205, audio sensor 110-a may detect a user input. For example, a user may communicate an action and a location which may be detected by a microphone of audio sensor 110-a. At 210, audio sensor 110-a may send the audio data to apparatus 135-a. At block 215, apparatus 135-a may analyze the audio data. At block 220, apparatus 135-a may identify a user status based at least in part on the analysis of the audio data at block 215.

At block 225, apparatus 135-a may query a database using at least a portion of the identified user status to make the query. For example, apparatus 135-a may search the database for an instance of an action and/or location provided in the audio data. As one example, the audio data may include “I'm reading in the living room.” Accordingly, apparatus 135-a may search the database for an instance of “reading” and/or “living room.”

At block 230, apparatus 135-a may identify at least one entry in the database that matches a portion of the query. At block 235, apparatus 135-a may identify in a matching entry one or more configuration settings. For example, apparatus 135-a may identify a configuration setting of at least one of an automated device and an automated sensor. At 240, apparatus 135-a may send an adjustment command to automated device 110-b. For example, automated device 110-b may include a light switch. Accordingly, apparatus 135-a may send a command to turn the light switch on or to adjust the light switch to a certain setting such as adjusting the light switch to a certain dimming level.

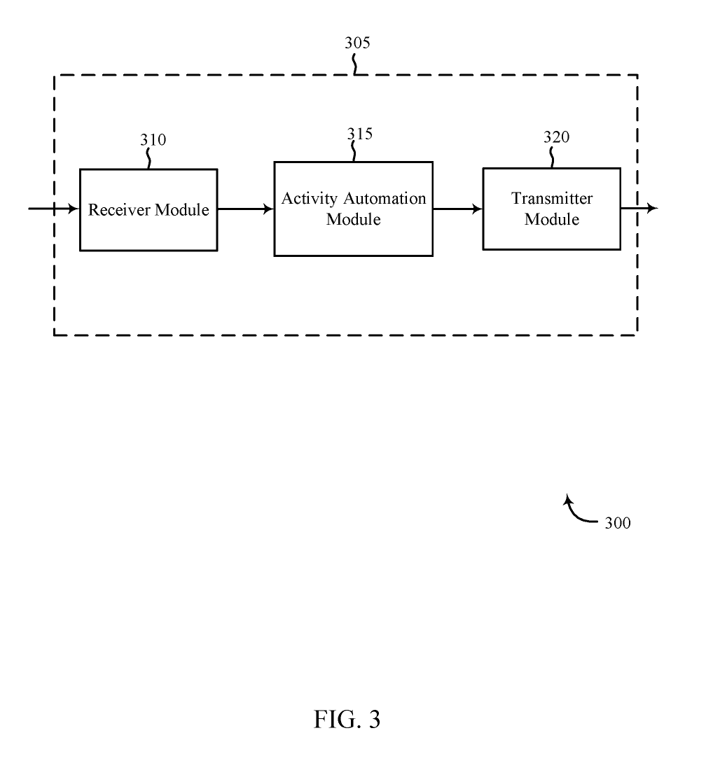

FIG. 3 shows a block diagram 300 of an apparatus 305 for use in electronic communication, in accordance with various aspects of this disclosure. The apparatus 305 may be an example of one or more aspects of a control panel 135 described with reference to FIG. 1. The apparatus 305 may include a receiver module 310, an activity automation module 315, and/or a transmitter module 320. The apparatus 305 may also be or include a processor. Each of these modules may be in communication with each other and/or other modules—directly and/or indirectly.

The components of the apparatus 305 may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each module may also be implemented—in whole or in part—with instructions embodied in memory formatted to be executed by one or more general and/or application-specific processors.

The receiver module 310 may receive information such as packets, user data, and/or control information associated with various information channels (e.g., control channels, data channels, etc.). The receiver module 310 may be configured to receive audio signals and/or data (e.g., spoken occupant status, voice command, etc.) and/or image signals and/or data (e.g., images of occupant gestures, etc.). Information may be passed on to the activity automation module 315, and to other components of the apparatus 305.

The activity automation module 315 may be configured to identify an occupant status and perform one or more automated actions based at least in part on the identified occupant status. Further details of activity automation module 315 are provided below.

The transmitter module 320 may transmit the one or more signals received from other components of the apparatus 305. The transmitter module 320 may transmit audio signals and/or data (e.g., spoken occupant status, voice commands, etc.) and/or images signals and/or data (e.g., images of occupant gestures, etc.). In some cases, transmitter module 320 may transmit results of data analysis on audio/image signals and/or data analyzed by activity automation module 315. In some examples, the transmitter module 320 may be collocated with the receiver module 310 in a transceiver module. In other examples, these elements may not be collocated.

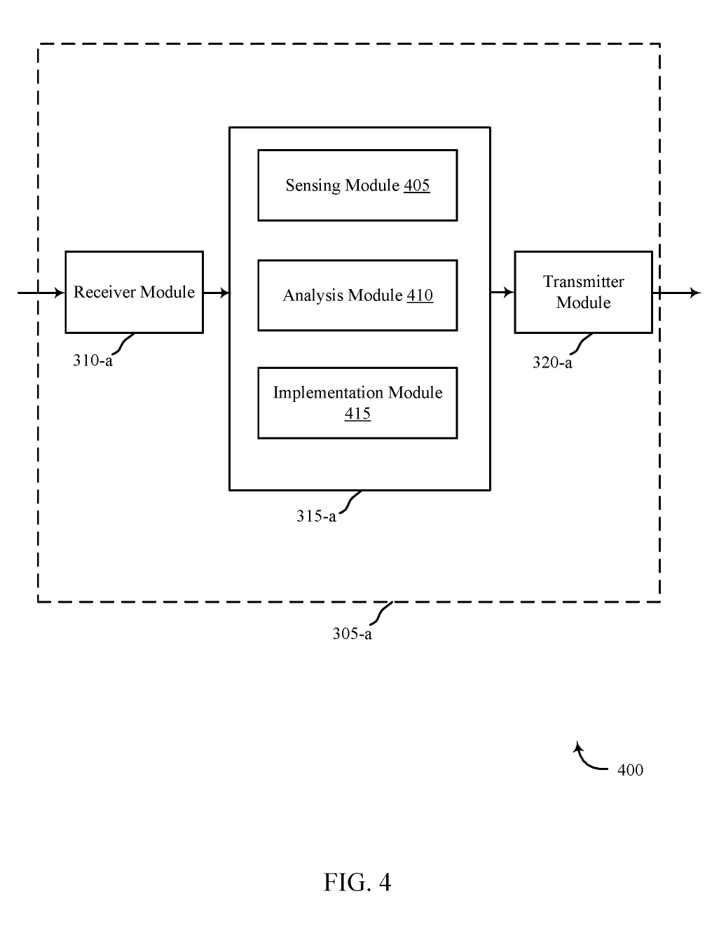

FIG. 4 shows a block diagram 400 of an apparatus 305-a for use in wireless communication, in accordance with various examples. The apparatus 305-a may be an example of one or more aspects of a control panel 135 described with reference to FIG. 1. It may also be an example of an apparatus 305 described with reference to FIG. 3. The apparatus 305-a may include a receiver module 310-a, an activity automation module 315-a, and/or a transmitter module 320-a, which may be examples of the corresponding modules of apparatus 305. The apparatus 305-a may also include a processor. Each of these components may be in communication with each other. The activity automation module 315-a may include sensing module 405, analysis module 410, and/or implementation module 415. The receiver module 310-a and the transmitter module 320-a may perform the functions of the receiver module 310 and the transmitter module 320, of FIG. 3, respectively.

In one embodiment, sensing module 405 may be configured to identify a status of an occupant of a premises. In some cases, the status of the occupant may include at least one of an action of the occupant and a location of the action. In some cases, one or more sensors associated with an automation system may detect an activity and/or location of an occupant.

In some embodiments, analysis module 410 may be configured to analyze one or more aspects of an automation system at the premises in relation to the sensing module 405 identifying a status of an occupant. In some cases, analysis module 410 may determine a setting of an automated device associated with a location of an activity and/or a location of an occupant. In some embodiments, implementation module 415 may be configured to implement and/or adjust one or more settings of the automated device upon identifying the status of the occupant.

In one embodiment, sensing module 405 may be configured to receive from the occupant at least one of the action of the occupant and the location of the action. For example, sensing module 405 may detect an occupant stating at least one of an action and a location of the action. As one example, the occupant may provide a spoken indication. For example, in some cases the occupant may provide the occupant status to the automation system via a voice command. Additionally or alternatively, the occupant may provide the status via a menu selection on a computing device, via a menu selection on a control panel, via a gesture detected by a camera and recognizable by the sensing module 405, or a combination thereof. As one example, an occupant may state “I'm exercising in the basement.”

In some cases, analysis module 410 may analyze the statement from the occupant. In some examples, analysis module 410 may parse the statement and/or convert the statement to text to determine that the activity of the occupant is exercising and the location of the activity is the basement. In some cases, analysis module 410 may analyze a detected gesture or pattern of gestures made by the occupant to determine the occupant status.

In some embodiments, sensing module 405 may detect a statement from the occupant via a microphone sensor associated with the automation system. In some examples, sensing module 405 may detect a statement via at least one of a microphone located in the premises and a microphone located outside the premises. In some cases, sensing module 405 may detect a statement from the occupant from at least one of a microphone on a mobile device communicatively connected to an automation system, a microphone on a laptop or desktop communicatively connected to the automation system, and a microphone on a control panel of the automation system, or any combination thereof.

In some examples, the sensing module 405 may detect the occupant providing at least one of an action and a location of the action via a text based message. For example, an occupant may enter an action and/or a location in an application associated with the automation system. In some cases, an occupant may send a message such as an email message, text message, or social media message that indicates at least one of an action and a location. Accordingly, sensing module 405 may receive the text based message from the occupant and provide the information to the analysis module 410.

In some embodiments, analysis module 410 may be configured to search a database associated with an automation system in relation to the sensing module 405 identifying a status of an occupant of a premises. As one example, analysis module 410 may search a database for an entry in the database that matches at least one of the action of the occupant and the location of the action. In some cases, the database may include one or more databases located at the premises. In some cases, the database may include one or more databases located at a first premises and one or more additional databases at a second premises. In some cases, the database may include a central database such as a database centrally located at a location remote to the premises. In some cases, the database may be located on a cloud storage system, on a remote server, on a distributed storage system, or any combination thereof. Accordingly, analysis module 410 implemented at a first premises may perform a first query of the central database and the analysis module 410 implemented at a second premises may perform a second query of the same central database. In some examples, the database may include a list of actions and/or locations. In some cases, the database may include a list of action and location combinations pre-programmed in the database.

In some embodiments, analysis module 410 may be configured to identify a matching entry of the database based at least in part on the search or query. In some embodiments, the matching entry may include one or more settings of at least one automated device and/or automated sensor. For example, the matching entry may include one or more settings for at least one of an automated light switch, automated component of an HVAC system, automated thermostat, automated HVAC flue, automated HVAC register dampers or louvers, automated window blinds, automated door lock, automated security camera, an automated sensor, or any combination thereof. Accordingly, analysis module 410 may identify in the matching entry one or more settings of at least one automated device or sensor. Thus, analysis module 410 may implement the one or more settings and/or adjust the automated device or sensor according to the one or more settings in the matching entry.

In some cases, analysis module 410 may determine a setting of an automated device situated along a path between a current location of an occupant and a location of an activity. For example, sensing module 405 may detect an occupant stating “I'm reading in the living room.” Analysis module 410 may determine that the occupant is in a bedroom when the occupant makes this statement. In some examples, analysis module 410 may detect one or more automated device in between the bedroom and the living room. For example, analysis module 410 may determine that an automated light is located between the bedroom and the living room. Accordingly, implementation module 415 may turn the automated light on until sensing module 405 determines the occupant is in the living room or that the occupant has walked past the automated light. In some cases, analysis module 410 may determine a time of day and turn on the automated light based at least in part on the determined time of day.

In some embodiments, sensing module 405 may receive from the occupant the action of the occupant without the location of the action. In some cases, upon identifying the action of the occupant without the location, implementation module 415 may implement the setting of the automated device upon determining the received action is associated with a preconfigured location. In some embodiments, implementation module 415 may be configured to implement the setting of the automated device upon determining the received action is location independent. As one example, a location independent action may include at least one of reading, operating a mobile computing device or laptop computing device, cleaning a premises, exercising in the premises, exercising outside the premises, gardening outside the premises, or any combination thereof. In one example, a location dependent action may include at least one of food preparation in a kitchen, washing dishes at a kitchen sink, taking a shower or bath in a bathroom, doing laundry in a laundry room, operating a television in a room that has the television, operating a desktop computer, cleaning a specific room or area of a premises, or any combination thereof

In some embodiments, upon determining the received action is location dependent and not associated with a preconfigured location, implementation module 415 may perform a query of the occupant for information regarding the location that may include at least one of sending a text message to the occupant, sending an email message to the occupant, playing a prerecorded message over a speaker at the premises, playing a text to speech message over the speaker, displaying a message on a control panel display, displaying a message on a computing device via a software application installed on the computing device, or any combination thereof.

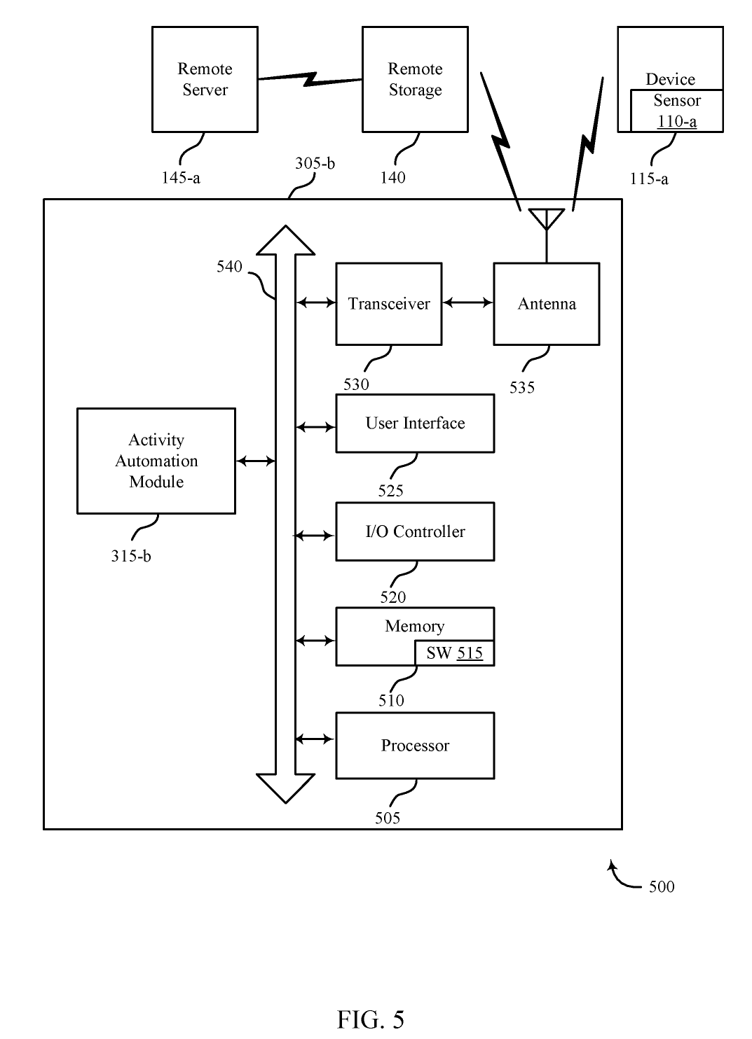

FIG. 5 shows a system 500 for use in automation systems, in accordance with various examples. System 500 may include an apparatus 305-b, which may be an example of the control panels 135 of FIGS. 1 and/or 2. Apparatus 305-b may also be an example of one or more aspects of apparatus 305 of FIGS. 3 and 4.

Apparatus 305-b may include components for bi-directional voice and data communications including components for transmitting communications and components for receiving communications. For example, apparatus 305-b may communicate bi-directionally with one or more of device 115-a, one or more sensors 110-a, remote storage 140, and/or remote server 145-a, which may be an example of the remote server of FIG. 1. This bi-directional communication may be direct (e.g., apparatus 305-b communicating directly with remote storage 140) and/or indirect (e.g., apparatus 305-b communicating indirectly with remote server 145-a through remote storage 140).

Apparatus 305-b may also include a processor module 505, and memory 510 (including software/firmware code (SW) 515), an input/output controller module 520, a user interface module 525, a transceiver module 530, and one or more antennas 535 each of which may communicate—directly or indirectly—with one another (e.g., via one or more buses 540). The transceiver module 530 may communicate bi-directionally—via the one or more antennas 535, wired links, and/or wireless links—with one or more networks or remote devices as described above. For example, the transceiver module 530 may communicate bi-directionally with one or more of device 115-a, remote storage 140, and/or remote server 145-a. The transceiver module 530 may include a modem to modulate the packets and provide the modulated packets to the one or more antennas 535 for transmission, and to demodulate packets received from the one 35, the control panel or the control device may also have multiple antennas 535 capable of concurrently transmitting or receiving multiple wired and/or wireless transmissions. In some embodiments, one element of apparatus 305-b (e.g., one or more antennas 535, transceiver module 530, etc.) may provide a direct connection to a remote server 145-a via a direct network link to the Internet via a POP (point of presence). In some embodiments, one element of apparatus 305-b (e.g., one or more antennas 535, transceiver module 530, etc.) may provide a connection using wireless techniques, including digital cellular telephone connection, Cellular Digital Packet Data (CDPD) connection, digital satellite data connection, and/or another connection.

The signals associated with system 500 may include wireless communication signals such as radio frequency, electromagnetics, local area network (LAN), wide area network (WAN), virtual private network (VPN), wireless network (using 802.11, for example), 345 MHz, Z-WAVE®, cellular network (using 3G and/or LTE, for example), and/or other signals. The one or more antennas 535 and/or transceiver module 530 may include or be related to, but are not limited to, WWAN (GSM, CDMA, and WCDMA), WLAN (including BLUETOOTH® and Wi-Fi), WMAN (WiMAX), antennas for mobile communications, antennas for Wireless Personal Area Network (WPAN) applications (including RFID and UWB). In some embodiments, each antenna 535 may receive signals or information specific and/or exclusive to itself. In other embodiments, each antenna 535 may receive signals or information not specific or exclusive to itself.

In some embodiments, one or more sensors 110-a (e.g., motion, proximity, smoke, light, glass break, door, audio, image, window, carbon monoxide, and/or another sensor) may connect to some element of system 500 via a network using one or more wired and/or wireless connections.

In some embodiments, the user interface module 525 may include an audio device, such as an external speaker system, an external display device such as a display screen, and/or an input device (e.g., remote control device interfaced with the user interface module 525 directly and/or through I/O controller module 520).

One or more buses 540 may allow data communication between one or more elements of apparatus 305-b (e.g., processor module 505, memory 510, I/O controller module 520, user interface module 525, etc.).

The memory 510 may include random access memory (RAM), read only memory (ROM), flash RAM, and/or other types. The memory 510 may store computer-readable, computer-executable software/firmware code 515 including instructions that, when executed, cause the processor module 505 to perform various functions described in this disclosure (e.g., identify occupant status, adjust an aspect of an automation system based on the identified occupant status, etc.). Alternatively, the software/firmware code 515 may not be directly executable by the processor module 505 but may cause a computer (e.g., when compiled and executed) to perform functions described herein. Alternatively, the computer-readable, computer-executable software/firmware code 515 may not be directly executable by the processor module 505 but may be configured to cause a computer (e.g., when compiled and executed) to perform functions described herein. The processor module 505 may include an intelligent hardware device, e.g., a central processing unit (CPU), a microcontroller, an application-specific integrated circuit (ASIC), etc.

In some embodiments, the memory 510 can contain, among other things, the Basic Input-Output system (BIOS) which may control basic hardware and/or software operation such as the interaction with peripheral components or devices. For example, the activity automation module 315 to implement the present systems and methods may be stored within the system memory 510. Applications resident with system 500 are generally stored on and accessed via a non-transitory computer readable medium, such as a hard disk drive or other storage medium. Additionally, applications can be in the form of electronic signals modulated in accordance with the application and data communication technology when accessed via a network interface (e.g., transceiver module 530, one or more antennas 535, etc.).

Many other devices and/or subsystems may be connected to and/or included as one or more elements of system 500 (e.g., entertainment system, computing device, remote cameras, wireless key fob, wall mounted user interface device, cell radio module, battery, alarm siren, door lock, lighting system, thermostat, home appliance monitor, utility equipment monitor, and so on). In some embodiments, all of the elements shown in FIG. 5 need not be present to practice the present systems and methods. The devices and subsystems can be interconnected in different ways from that shown in FIG. 5. In some embodiments, an aspect of some operation of a system, such as that shown in FIG. 5, may be readily known in the art and are not discussed in detail in this application. Code to implement the present disclosure can be stored in a non-transitory computer-readable medium such as one or more of system memory 510 or other memory. The operating system provided on I/O controller module 520 may be iOS®, ANDROID®, MS-DOS®, MS-WINDOWS®, OS/2®, UNIX®, LINUX®, or another known operating system.

The transceiver module 530 may include a modem configured to modulate the packets and provide the modulated packets to the antennas 535 for transmission and/or to demodulate packets received from the antennas 535. While the control panel or control device (e.g., 305-b) may include a single antenna 535, the control panel or control device (e.g., 305-b) may have multiple antennas 535 capable of concurrently transmitting and/or receiving multiple wireless transmissions. The apparatus 305-b may include an activity automation module 315-b, which may perform the functions described above for the activity automation module 315 of apparatus 305 of FIGS. 3 and/or 4.

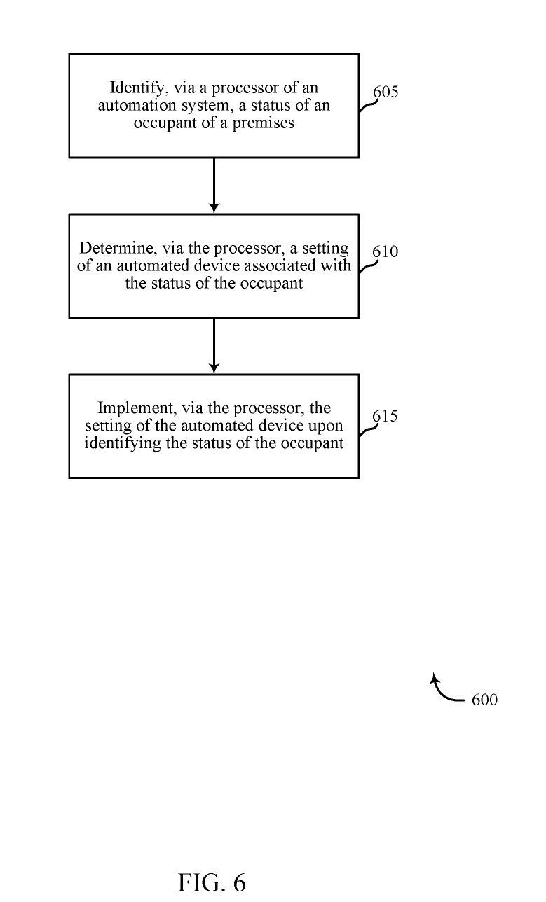

FIG. 6 is a flow chart illustrating an example of a method 600 for home automation, in accordance with various aspects of the present disclosure. For clarity, the method 600 is described below with reference to aspects of one or more of the sensor units 110 described with reference to FIGS. 1, 2, and/or 5. In some examples, a control panel, backend server, mobile computing device, and/or sensor may execute one or more sets of codes to control the functional elements of the control panel, backend server, mobile computing device, and/or sensor to perform one or more of the functions described below. Additionally or alternatively, the control panel, backend server, mobile computing device, and/or sensor may perform one or more of the functions described below using special-purpose hardware.

At block 605, method 600 may include identifying, via a processor of an automation system, a status of an occupant of a premises. In some cases, the status of the occupant may include at least one of an action of the occupant and a location of the action. At block 610, method 600 may include determining, via the processor, a setting of an automated device associated with the status of the occupant. At block 615, method 600 may include implementing, via the processor, the setting of the automated device upon identifying the status of the occupant. The operation(s) at block 605-615 may be performed using the activity automation module 315 described with reference to FIGS. 3-5 and/or another module.

Thus, the method 600 may provide improved configuration and implementation relating to automation/security systems. It should be noted that the method 600 is just one implementation and that the operations of the method 600 may be rearranged, omitted, and/or otherwise modified such that other implementations are possible and contemplated.

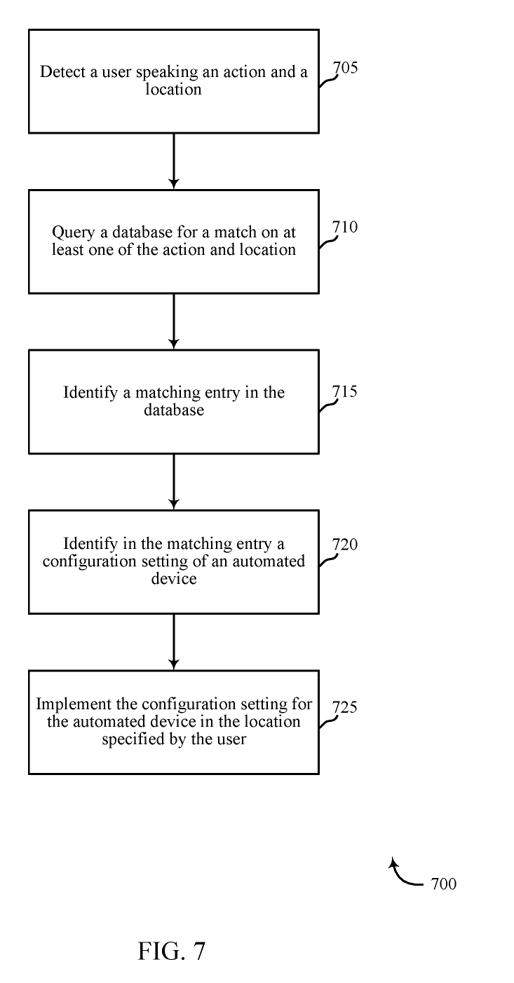

FIG. 7 is a flow chart illustrating an example of a method 700 for home automation, in accordance with various aspects of the present disclosure. For clarity, the method 700 is described below with reference to aspects of one or more of the sensor units 110 described with reference to FIGS. 1, 2, and/or 5. In some examples, a control panel, backend server, mobile computing device, and/or sensor may execute one or more sets of codes to control the functional elements of the control panel, backend server, mobile computing device, and/or sensor to perform one or more of the functions described below. Additionally or alternatively, the control panel, backend server, mobile computing device, and/or sensor may perform one or more of the functions described below using special-purpose hardware.

At block 705, method 700 may include detecting a user speaking an action and a location. At block 710, method 700 may include querying a database for a match on at least one of the action and location. At block 715, method 700 may include identifying a matching entry in the database. At block 720, method 700 may include identifying in the matching entry a configuration setting of an automated device. At block 725, method 700 may include implementing the configuration setting for the automated device in the location specified by the user. The operations at blocks 705-725 may be performed using the activity automation module 315 described with reference to FIGS. 3-5 and/or another module.

Thus, the method 700 may provide improved configuration and implementation relating to automation/security systems. It should be noted that the method 700 is just one implementation and that the operations of the method 700 may be rearranged, omitted, and/or otherwise modified such that other implementations are possible and contemplated.

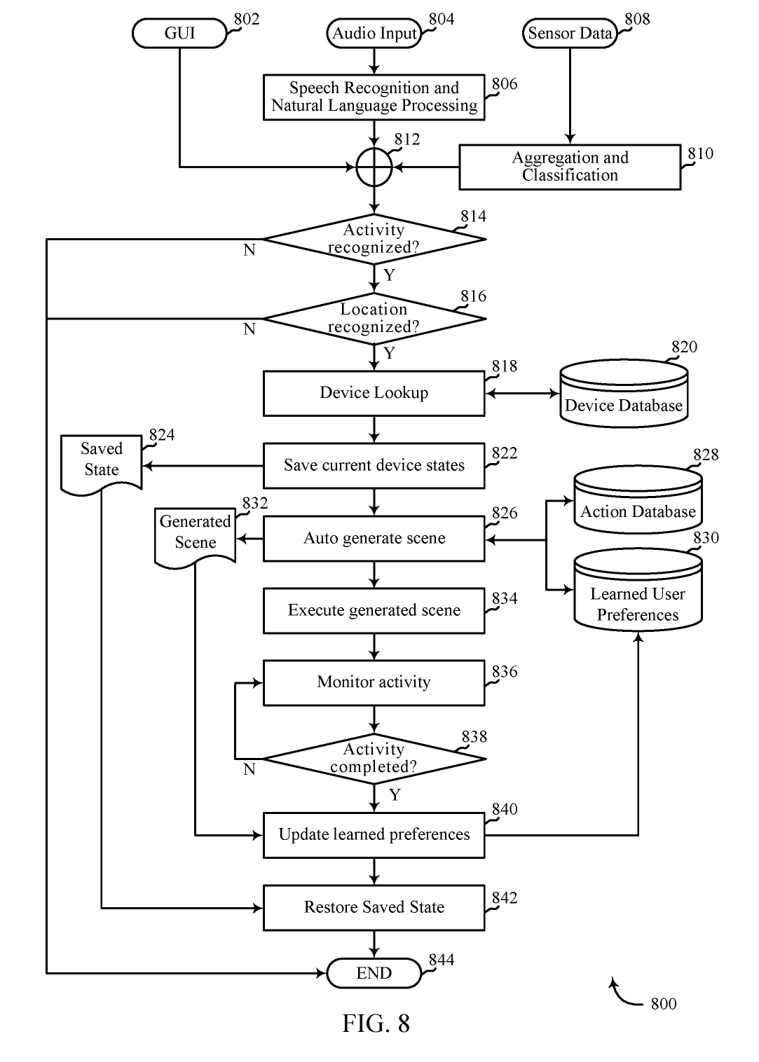

FIG. 8 is a flow chart illustrating an example of a method 800 for home automation, in accordance with various aspects of the present disclosure. For clarity, the method 800 is described below with reference to aspects of one or more of the sensor units 110 described with reference to FIGS. 1, 2, and/or 5. In some examples, a control panel, backend server, mobile computing device, and/or sensor may execute one or more sets of codes to control the functional elements of the control panel, backend server, mobile computing device, and/or sensor to perform one or more of the functions described below. Additionally or alternatively, the control panel, backend server, mobile computing device, and/or sensor may perform one or more of the functions described below using special-purpose hardware.

In some embodiments, the method 800 may include a user interface. As illustrated, at block 802 method 800 may include a graphical user interface (GUI). The GUI of method 800 may be one example of user interface module 525 of FIG. 5. In some cases, the GUI of method 800 may provide an interface that enables a user to specify an action and/or location in relation to operations and automatable components of an automation system.

At block 804 method 800 may include an audio input. In some cases, at block 804 method 800 may receive an audio input from an occupant of a premises associated with an automation system of the premises. At block 806 method 800 may process the audio input of block 804 using speech recognition and natural language processing.

At block 808, method 800 may use one or more sensors to detect at least one of an action of an occupant and a location of an occupant or location of an action. Sensors 110 of FIGS. 1, 2, and/or 5 may be examples of sensors method 800 uses to detect at least one of an action of an occupant and a location of an occupant or action. At block 810, method 800 may aggregate detection data and/or signals from one or more sensors used to detect at least one of an action of an occupant and a location of an occupant or action. Additionally or alternatively, at block 810 method 800 may classify detection data and/or signals from one or more sensors used to detect at least one of an action of an occupant and a location of an occupant or action.

At block 812, method 800 may include aggregating data from at least one of the GUI of block 802, the audio input of block 804, and the sensor data of block 808, or any combination thereof.

At block 814, method 800 may determine whether a detected activity is recognized by the automation system. When method 800 recognizes the activity, method 800 may continue to block 816. When method 800 does not recognize the activity, method 800 may proceed to block 844, ending the current process. In some cases, when method 800 does not recognize the activity, method 800 may continue monitoring for one or more inputs in relation at least one of the GUI of block 802, the audio input of block 804, and the sensor data of block 808, or any combination thereof.

At block 816, method 800 may determine whether a detected location is recognized by the automation system. When method 800 recognizes the location, method 800 may continue to block 818. When method 800 does not recognize the activity, method 800 may proceed to block 844, ending the current process.

At block 818, method 800 may perform a device lookup. In some cases, method 800 may query a device database 820 to determine whether at least one device is associated with the detected location. For example, method 800 may determine that an automatable light switch is associated with the detected location.

At block 822, method 800 may save a current device state of the one or more devices associated with the detected location. As one example, method 800 may determine that an automatable device associated with the detected location has a current setting such as an automatable light switch being in an OFF position. At block 822, method 800 may save the saved state 824 in a memory device and/or storage device such as memory 510 of FIG. 5, remote storage 140 of FIG. 5, device database 820, or another memory or storage device.

At block 826, method 800 may auto-generate a scene for the detected location. In some cases, the auto-generated scene may include one or more settings for automatable devices located in the detected location. For example, the auto-generated scene may include settings for automatable light switches, automatable thermostats, automatable HVAC settings, automatable HVAC register settings, and the like. In some cases, method 800 may query action database 828 for one or more configuration settings associated with the detected action. For example, method 800 may determine that the detected action is “reading a book.” Accordingly, method 800 may identify in action database 828 one or more automatable device settings associated with the action “reading a book.” In some cases, method 800 may query a learned user preferences database 830 for one or more preferences associated with the detected action and/or detected location. For example, method 800 may detect and store user preferences associated with automatable device settings located in the detected location and/or settings for automatable devices located in other locations in the premises. In some cases, method 800 may auto-generate a scene based on information received from a query of at least one of the action database 828 and the learned user preferences database 830. At block 826, method 800 may save the generated scene 832 in a memory device and/or storage device such as memory 510 of FIG. 5, remote storage 140 of FIG. 5, device database 820, or another memory or storage device.

At block 834, method 800 may include executing the generated scene 832. At block 836, the method may include monitoring the detected activity. For example, method 800 may determine that the activity of the occupant is “exercising” and the location is “the basement.” Accordingly, method 800 may use one or more automatable sensors and/or devices to monitor the occupant exercising in the basement. Based on the monitoring, method 800 may determine whether the occupant has started exercising, is continuing to exercise, has stopped exercising, etc.

At block 838, based on the monitoring of block 838, method 800 may determine whether the detected activity is completed. When method 800 determines the activity is completed, method 800 may proceed to block 840. Otherwise, when method 800 determines the activity is not completed, method 800 may continue monitoring the activity at block 836.

At block 840, method 800 may update learned user preferences database 830. In some cases, method 800 may use one or more aspects from the generated scene 832 to update learned user preferences database 830. For example, the occupant may adjust one or more automatable sensors and/or devices in relation to performing the detected activity at the detected location such as adjusting a thermostat setting for the detected location. Method 800 may identify these occupant adjustments and update learned user preferences database 830 based on the identified adjustments.

At block 842, method 800 may restore a saved state associated with at least one of automatable sensors and/or devices associated with the detected location, and automatable sensors and/or devices associated with other locations of the premises. As illustrated, at block 842 method 800 may restore a state of one or more automatable sensors and/or devices based on information from the saved state 824 saved at block 822. At block 844, method 800 may end the current process.

Thus, the method 800 may provide improved configuration and implementation relating to automation/security systems. It should be noted that the method 800 is just one implementation and that the operations of the method 800 may be rearranged, omitted, and/or otherwise modified such that other implementations are possible and contemplated.

In some examples, aspects from two or more of the methods 600, 700, and 800 may be combined and/or separated. It should be noted that the methods 600, 700, and 800 are just example implementations, and that the operations of the methods 600, 700, and 800 may be rearranged or otherwise modified such that other implementations are possible.

The detailed description set forth above in connection with the appended drawings describes examples and does not represent the only instances that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with this disclosure may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, and/or state machine. A processor may also be implemented as a combination of computing devices, e.g., a combination of a DSP and a microprocessor, multiple microprocessors, one or more microprocessors in conjunction with a DSP core, and/or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

In addition, any disclosure of components contained within other components or separate from other components should be considered exemplary because multiple other architectures may potentially be implemented to achieve the same functionality, including incorporating all, most, and/or some elements as part of one or more unitary structures and/or separate structures.

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM, DVD, or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed.

This disclosure may specifically apply to security system applications. This disclosure may specifically apply to automation system applications. In some embodiments, the concepts, the technical descriptions, the features, the methods, the ideas, and/or the descriptions may specifically apply to security and/or automation system applications. Distinct advantages of such systems for these specific applications are apparent from this disclosure.

The process parameters, actions, and steps described and/or illustrated in this disclosure are given by way of example only and can be varied as desired. For example, while the steps illustrated and/or described may be shown or discussed in a particular order, these steps do not necessarily need to be performed in the order illustrated or discussed. The various exemplary methods described and/or illustrated here may also omit one or more of the steps described or illustrated here or include additional steps in addition to those disclosed.

Furthermore, while various embodiments have been described and/or illustrated here in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may permit and/or instruct a computing system to perform one or more of the exemplary embodiments disclosed here.

This description, for purposes of explanation, has been described with reference to specific embodiments. The illustrative discussions above, however, are not intended to be exhaustive or limit the present systems and methods to the precise forms discussed. Many modifications and variations are possible in view of the above teachings. The embodiments were chosen and described in order to explain the principles of the present systems and methods and their practical applications, to enable others skilled in the art to utilize the present systems, apparatus, and methods and various embodiments with various modifications as may be suited to the particular use contemplated.

What is claimed is:

1. A method for security and/or automation systems, comprising:
identifying, via a processor of an automation system, a status of an occupant of a premises, the status of the occupant including at least one of an action of the occupant and a location of the action;
determining, via the processor, a setting of an automated device associated with the status of the occupant; and
implementing, via the processor, the setting of the automated device upon identifying the status of the occupant.

2. The method of claim 1, comprising:
receiving from the occupant the action of the occupant and the location of the action.

3. The method of claim 2, comprising:
searching a database associated with the automation system for an entry in the database that matches from the identified status of the occupant at least one of the action of the occupant and the location of the action.

4. The method of claim 3, comprising:
identifying a matching entry of the database based at least in part on the search; and
identifying the setting of the automated device in the matching entry.

5. The method of claim 1, comprising:
receiving from the occupant the action of the occupant without the location of the action.

6. The method of claim 5, comprising:
implementing the setting of the automated device upon determining the received action is associated with a preconfigured location.

7. The method of claim 5, comprising:
implementing the setting of the automated device upon determining the received action is location independent.

8. The method of claim 2, comprising:
upon determining the received action is location dependent and not associated with a preconfigured location, performing a query of the occupant for information regarding the location that includes at least one of sending a text message to the occupant, sending an email message to the occupant, playing a prerecorded message over a speaker at the premises, playing a text to speech message over the speaker, or any combination thereof.

9. The method of claim 8, comprising:
wherein a location independent action includes at least one of reading, operating a mobile computing device or laptop computing device, cleaning the premises, exercising in the premises, exercising outside the premises, gardening outside the premises, or any combination thereof; and
wherein a location dependent action includes at least one of food preparation, washing dishes, doing laundry, operating a television, operating a desktop computer, or any combination thereof.

10. The method of claim 2, wherein the occupant provides the occupant status to the automation system via a voice command, via a menu selection on a computing device, via a menu selection on a control panel, or a combination thereof.

11. An apparatus for an automation system, comprising:
a processor of an automation system;
memory in electronic communication with the processor; and
instructions stored in the memory, the instructions being executable by the processor to:
identify a status of an occupant of a premises, the status of the occupant including at least one of an action of the occupant and a location of the action;
determine a setting of an automated device associated with the status of the occupant; and
implement the setting of the automated device upon identifying the status of the occupant.

12. The apparatus of claim 11, the instructions being executable by the processor to:
receive from the occupant the action of the occupant and the location of the action.

13. The apparatus of claim 12, the instructions being executable by the processor to:
search a database associated with the automation system for an entry in the database that matches from the identified status of the occupant at least one of the action of the occupant and the location of the action.

14. The apparatus of claim 13, the instructions being executable by the processor to:
identify a matching entry of the database based at least in part on the search; and
identify the setting of the automated device in the matching entry.

15. The apparatus of claim 11, the instructions being executable by the processor to:
receive from the occupant the action of the occupant without the location of the action.

16. The apparatus of claim 15, the instructions being executable by the processor to:
implement the setting of the automated device upon determining the received action is associated with a preconfigured location.

17. The apparatus of claim 15, the instructions being executable by the processor to:
implement the setting of the automated device upon determining the received action is location independent.

18. The apparatus of claim 17, the instructions being executable by the processor to:
upon determining the received action is location dependent and not associated with a preconfigured location, perform a query of the occupant for information regarding the location that includes at least one of sending a text message to the occupant, sending an email message to the occupant, playing a prerecorded message over a speaker at the premises, playing a text to speech message over the speaker, or any combination thereof

19. A non-transitory computer-readable medium storing computer-executable code for an automation system, the code executable by a processor of the automation system to:
identify a status of an occupant of a premises, the status of the occupant including at least one of an action of the occupant and a location of the action;
determine a setting of an automated device associated with the status of the occupant; and
implement the setting of the automated device upon identifying the status of the occupant.

20. The storage medium of claim 19, the code executable by the processor to:
receive from the occupant the action of the occupant and the location of the action.
